(19) United States
(12) Patent Application Publication
(10) Pub. No.: US 2026/0299637 A1
(43) Pub. Date: Oct. 1, 2026

(54) WAFER-LEVEL INTELLIGENT PHOTONIC COMPUTING CHIP SYSTEM AND ARCHITECTURE

(71) Applicant: TSINGHUA UNIVERSITY, BEIJING (CN)

(72) Inventors: LU FANG, BEIJING (CN); ZHIHAO XU, BEIJING (CN)

(21) Appl. No.: 19/630,377

(22) Filed: Mar. 26, 2026

(30) Foreign Application Priority Data
Mar. 28, 2025 (CN) 2025103797292

(51) Int. Cl. G06E 1/00

(52) U.S. Cl. CPC G06E 1/00

(57) ABSTRACT

A wafer-level intelligent photonic computing chip system includes: a high-efficiency information encoder, configured to obtain a first encoded vector by performing multi-path information channel encoding and compression on an input matrix via a diffractive encoder; a reconfigurable information encoder, configured to obtain a second encoded vector by performing multi-path information reconfigurable computation weight on the input matrix; a universal feature computer, configured to obtain a feature vector by performing universal feature computation on the first encoded vector and the second encoded vector; a high-efficiency feature decoder, configured to obtain a first decoded vector by performing first decoding representation on the feature vector; a reconfigurable feature decoder, configured to obtain a second decoded vector by performing second decoding representation on the feature vector; and an output processing element, configured to obtain a target computation result by synthesizing the first decoded vector and the second decoded vector.

### CROSS-REFERENCE TO RELATED PATENT APPLICATION

This application is based on and claims priority to Chinese patent application No. 2025103797292, filed on Mar. 28, 2025, the entire content of which is hereby incorporated into this application by reference.

### FIELD OF THE DISCLOSURE

The present disclosure relates to a field of photonic computing technologies, and particularly to a wafer-level intelligent photonic computing chip system and architecture.

### BACKGROUND OF THE DISCLOSURE

With rapid development of artificial intelligence and scientific computing, complexity and scale of computation requirements are also continuously increasing. However, performance of existing electronic computing is gradually approaching its limits, making it difficult to effectively meet increasingly demanding requirements for computing power and energy efficiency posed by large-scale complex algorithms. Light propagation possesses inherent advantages such as high throughput and low latency. Photonic computing technology, which uses photons instead of electrons as a computing medium, is therefore regarded as a key to overcoming a current computational bottleneck.

### SUMMARY OF THE DISCLOSURE

A wafer-level intelligent photonic computing chip system is provided in a first aspect of the present disclosure. The system includes: a high-efficiency information encoder, configured to obtain a first encoded vector by performing multi-path information channel encoding and compression on an input matrix via a diffractive encoder;
a reconfigurable information encoder, configured to obtain a second encoded vector by performing multi-path information reconfigurable computation weight on the input matrix via a phase modulator or an amplitude modulator;
a universal feature computer, configured to obtain a feature vector by performing universal feature computation on the first encoded vector and the second encoded vector;
a high-efficiency feature decoder, configured to obtain a first decoded vector by performing first decoding representation on the feature vector, in which a structure of the high-efficiency feature decoder is dual to a structure of the high-efficiency information encoder;
a reconfigurable feature decoder, configured to obtain a second decoded vector by performing second decoding representation on the feature vector, in which a structure of the reconfigurable feature decoder is dua to a structure of the reconfigurable information encoder; and
an output processing element, configured to obtain a target computation result by synthesizing the first decoded vector and the second decoded vector.

A computing method based on a wafer-level intelligent photonic computing chip system is provided in a second aspect of the present disclosure. The method includes:
obtaining an input matrix to be computed, and obtaining a first encoded vector by performing multi-path information channel encoding and compression on the input matrix;
obtaining a second encoded vector by performing multi-path information reconfigurable computation weight on the input matrix;
obtaining a feature vector by performing universal feature computation on the first encoded vector and the second encoded vector;
obtaining a first decoded vector by performing first decoding representation on the feature vector;
obtaining a second decoded vector by performing second decoding representation on the feature vector; and
obtaining a target computation result by synthesizing the first decoded vector and the second decoded vector.

The present disclosure provides a computer storage medium. The computer storage medium stores computer executable instructions which, when executed by a processor, cause a computing method based on a wafer-level intelligent photonic computing chip system to be implemented. The method includes:
obtaining an input matrix to be computed, and obtaining a first encoded vector by performing multi-path information channel encoding and compression on the input matrix;
obtaining a second encoded vector by performing multi-path information reconfigurable computation weight on the input matrix;
obtaining a feature vector by performing universal feature computation on the first encoded vector and the second encoded vector;
obtaining a first decoded vector by performing first decoding representation on the feature vector;
obtaining a second decoded vector by performing second decoding representation on the feature vector; and
obtaining a target computation result by synthesizing the first decoded vector and the second decoded vector.

Additional aspects and advantages of the present disclosure will be given in part in the following descriptions, become apparent in part from the following descriptions, or be learned from the practice of the present disclosure.

### BRIEF DESCRIPTION OF THE DRAWINGS

These and other aspects and advantages of the present disclosure will become apparent and more readily appreciated from the following descriptions made with reference to the drawings, in which:

FIG. 1 is a schematic diagram illustrating a structure of a wafer-level intelligent photonic computing chip system according to an embodiment of the present disclosure.

FIG. 2 is a schematic diagram illustrating a structure of a wafer-level intelligent photonic computing chip architecture according to an embodiment of the present disclosure.

FIG. 3 is a flowchart illustrating a computation method of a wafer-level intelligent photonic computing chip system according to an embodiment of the present disclosure.

### DETAILED DESCRIPTION OF THE EXEMPLARY EMBODIMENTS

Reference will be made in detail to embodiments of the present disclosure. Examples of the embodiments of the present disclosure will be shown in drawings, in which the same or similar elements and the elements having same or similar functions are denoted by like reference numerals throughout the descriptions. The embodiments described herein with reference to drawings are illustrative, and used to generally understand the present disclosure. The embodiments shall not be construed to limit the present disclosure.

Currently, for most analog computing architectures, a signal may attenuate during transmission and processing, and noise may also affect a quality of the signal. This may lead to an error or instability in a computing result. For a photonic computing model, due to factors such as material defects, wavefront errors, and uneven transmission in an optical system, various errors may inevitably be introduced in optical computing. These errors may affect an accuracy of the computing result and cause a deviation between an experimental result and simulation data. If the number of parameters in an optical neural network is expanded simply by stacking layers, it will cause errors to gradually accumulate during propagation, eventually leading to significant adverse effects on an output.

In related arts, classification of four vowel sound wave signals may be achieved using an array of 56 cascaded Mach-Zehnder interferometers (MZIs). Or, a deep diffractive neural network based on cascaded optical diffraction masks has been implemented to perform visual tasks such as handwritten digit recognition and image saliency detection. Furthermore, a capability for multi-channel parallel processing in diffractive optical computing is endowed through splitting and clustering of optical paths.

However, due to presence of an error in a process of simulation computation and optical calibration, scalability of a common paradigm of optical computing based on interference and diffraction is limited and cannot be extended to a large-scale application, thus limiting complexity of intelligent optical computing tasks.

Reference is made in detail below to the present disclosure with reference to specific embodiments.

A wafer-level intelligent photonic computing chip system is provided in embodiments of a first aspect of the present disclosure. The system includes:
a high-efficiency information encoder, configured to obtain a first encoded vector by performing multi-path information channel encoding and compression on an input matrix via a diffractive encoder;
a reconfigurable information encoder, configured to obtain a second encoded vector by performing multi-path information reconfigurable computation weight on the input matrix via a phase modulator or an amplitude modulator;
a universal feature computer, configured to obtain a feature vector by performing universal feature computation on the first encoded vector and the second encoded vector;
a high-efficiency feature decoder, configured to obtain a first decoded vector by performing first decoding representation on the feature vector, in which a structure of the high-efficiency feature decoder is dual to a structure of the high-efficiency information encoder;
a reconfigurable feature decoder, configured to obtain a second decoded vector by performing second decoding representation on the feature vector, in which a structure of the reconfigurable feature decoder is dua to a structure of the reconfigurable information encoder; and
an output processing element, configured to obtain a target computation result by synthesizing the first decoded vector and the second decoded vector.

In an embodiment, the high-efficiency information encoder and the reconfigurable information encoder are deployed on a wafer.

In an embodiment, the universal feature computer is configured to obtain the feature vector by performing the universal feature computation on the first encoded vector and the second encoded vector via a fully reconfigurable arbitrary matrix computing element based on a Mach-Zehnder interferometer (MZI) or cross-bar structure.

In an embodiment, the system further includes: an auxiliary, configured to assist the wafer-level intelligent photonic computing chip system to complete a large-scale and high-parameter complex intelligent operation task.

In an embodiment, the auxiliary includes a high-speed interface array, a high-speed modulator, a loader, and a data router, in which, the high-speed interface array is configured for data coupling and readout; the high-speed modulator is configured for high-speed modulation of computing information; the loader is configured for loading of an electric control signal; and the data router is configured for data routing and monitoring.

In an embodiment, the system includes a configurable array of high-efficiency information encoders, and each diffractive encoder in the array has a weight distribution orthogonal to each other and independent features.

In an embodiment, the output processing element is configured to obtain the target computation result by performing weighted synthesization on the first decoded vector and the second decoded vector.

To achieve the above objective, a computing method based on the wafer-level intelligent photonic computing chip system as described in the first aspect is provided in embodiments of a second aspect of the present disclosure. The method includes:
obtaining an input matrix to be computed, and obtaining a first encoded vector by performing multi-path information channel encoding and compression on the input matrix;
obtaining a second encoded vector by performing multi-path information reconfigurable computation weight on the input matrix;
obtaining a feature vector by performing universal feature computation on the first encoded vector and the second encoded vector;
obtaining a first decoded vector by performing first decoding representation on the feature vector;
obtaining a second decoded vector by performing second decoding representation on the feature vector; and
obtaining a target computation result by synthesizing the first decoded vector and the second decoded vector.

The present disclosure provides an electronic device. The electronic device includes at least one processor; and a memory communicatively connected to the at least one processor. The memory stores instructions executable by the at least one processor, and the instructions are executed by the at least one processor to cause the at least one processor to perform the method as described in the second aspect.

The present disclosure provides a computer storage medium. The computer storage medium stores computer executable instructions which, when executed by a processor, cause the method as described in the second aspect to be implemented.

To sum up, the wafer-level intelligent photonic computing chip system and architecture provided in the disclosure, with collaborative operation of the high-efficiency information encoder, the reconfigurable information encoder, the universal feature computer, the high-efficiency feature decoder, and the reconfigurable feature decoder, optical implementation of intelligent computing networks with higher parameter counts may be supported. This scales up computational capacity, enabling large-scale models with over 100 million parameters to be implemented via photonic computing, supporting high-efficiency computation required for next-generation large-model artificial intelligence.

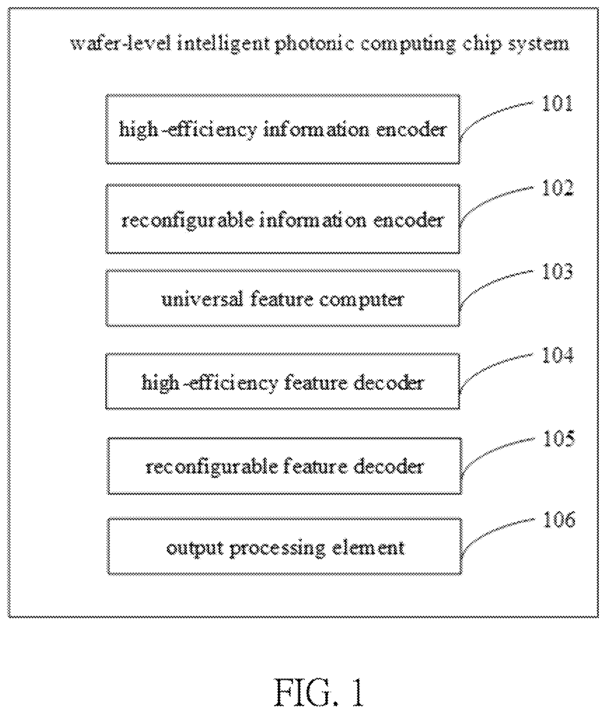

FIG. 1 is a schematic diagram illustrating a structure of a wafer-level intelligent photonic computing chip system according to an embodiment of the present disclosure. As illustrated in FIG. 1, the system includes a high-efficiency information encoder 101, a reconfigurable information encoder 102, a universal feature computer 103, a high-efficiency feature decoder 104, a reconfigurable feature 15 and decoder 105, and an output processing element 106.

The high-efficiency information encoder 101 is configured to obtain a first encoded vector by performing multi-path information channel encoding and compression on an input matrix via a diffractive encoder.

The reconfigurable information encoder 102 is configured to obtain a second encoded vector by performing multi-path information reconfigurable computation weight on the input matrix via a phase modulator or an amplitude modulator.

The universal feature computer 103 is configured to obtain a feature vector by performing universal feature computation on the first encoded vector and the second encoded vector.

The high-efficiency feature decoder 104 is configured to obtain a first decoded vector by performing first decoding representation on the feature vector, in which a structure of the high-efficiency feature decoder is dual to a structure of the high-efficiency information encoder.

The reconfigurable feature decoder 105 is configured to obtain a second decoded vector by performing second decoding representation on the feature vector, in which a structure of the reconfigurable feature decoder is dua to a structure of the reconfigurable information encoder.

The output processing element 106 is configured to obtain a target computation result by synthesizing the first decoded vector and the second decoded vector.

In an embodiment of the present disclosure, the above wafer-level intelligent photonic computing chip system is applicable to large-matrix computing. Based on this, the above wafer-level intelligent photonic computing chip system may be applicable to a variety of scenarios, such as classification of intelligent computing tasks.

In an embodiment of the present disclosure, the above high-efficiency information encoder may perform multi-path information channel encoding and compression on the input matrix using an on-chip diffraction computing element with pre-trained parameters, to achieve channel redundancy elimination. In an embodiment of the present disclosure, the above high-efficiency information encoder is based on passive modulation and non-reconfigurable weights, with high area efficiency and low computing energy consumption. In an embodiment of the present disclosure, the above system may include a configurable array of high-efficiency information encoders that can be set, and each diffractive encoder in the array has a weight distribution orthogonal to each other and independent features. For example, on a wafer-level chip system, the array composed of the above modules is mainly used for preliminary modulation and semantic extraction of information, and arrays of varying sizes may be activated based on task difficulty.

In an embodiment of the present disclosure, the above reconfigurable information encoder may provide a precise reconfigurable computation weight for multi-path information of the input matrix using a phase modulator or an amplitude modulator, and fuse the multi-path information. In an embodiment of the present disclosure, the above reconfigurable information encoder may be based on active modulation and trainable weights, with a high degree of computational freedom, and may be used for weight migration between different computing tasks in general computing. In an embodiment of the present disclosure, the above reconfigurable information encoder may serve as a supplement to the high-efficiency information encoder, and be deployed paired with the high-efficiency information encoder on a wafer.

Furthermore, in an embodiment of the present disclosure, the universal feature computer may be implemented via depth-wise or breadth-wise cascaded multiplexing of a fully reconfigurable arbitrary matrix computing element based on a MZI or cross-bar structure, and obtain the feature vector by performing the universal feature computation on the first encoded vector and the second encoded vector, to realize any scale of universal feature computation. The universal feature computer performs further high-degree-of-freedom computation processing on the first encoded vector and the second encoded vector generated by the above encoding, and its weights may be flexibly switched. Its weights can be flexibly switched depending on different tasks. In an embodiment of the present disclosure, for the above universal feature computer, a plurality of universal feature computers may be deployed on a wafer-level chip system, and the universal feature computer may be selectively activated and expanded according to a computation scale.

Furthermore, in an embodiment of the present disclosure, the high-efficiency feature decoder may use a structure dual to a structure of the high-efficiency information encoder and a pre-trained decoding weight to perform decoding representation on the feature vector of the universal feature computer, mapping the feature vector to a second decoded vector output by an intermediate layer of a high-dimensional network. The high-efficiency feature decoder may be deployed in a multi-core form on the wafer-level system, and a computing array with orthogonal decoding weights expands an output dimension.

Furthermore, in an embodiment of the present disclosure, the reconfigurable feature decoder may achieve task versatility of feature decoding representation using a structure dua to a structure of the reconfigurable information encoder and pre-trained weights as a supplement to the high-efficiency feature decoder.

In an embodiment of the present disclosure, the output processing element obtains the target computation result by performing weighted synthesization on the first decoded vector and the second decoded vector.

In an embodiment of the present disclosure, the system may further include an auxiliary, configured to assist the wafer-level intelligent photonic computing chip system to complete a large-scale and high-parameter complex intelligent operation task. The auxiliary includes a high-speed interface array, a high-speed modulator, a loader, and a data router.

The high-speed interface array is configured for data coupling and readout; the high-speed modulator is configured for high-speed modulation of computing information; the loader is configured for loading of an electric control signal; and the data router is configured for data routing and monitoring.

In an embodiment of the present disclosure, the auxiliary may cooperate with the above modules to form a wafer-level element array to achieve the large-scale and high-parameter complex intelligent operation task.

To sum up, the wafer-level intelligent photonic computing chip system provided in the embodiments, with collaborative operation of the high-efficiency information encoder, the reconfigurable information encoder, the universal feature computer, the high-efficiency feature decoder, and the reconfigurable feature decoder, optical implementation of intelligent computing networks with higher parameter counts may be supported. This scales up computational capacity, enabling large-scale models with over 100 million parameters to be implemented via photonic computing, supporting high-efficiency computation required for next-generation large-model artificial intelligence, and has broad application prospects, for example, may be applied to unmanned systems, autonomous driving, ultrafast science and other fields.

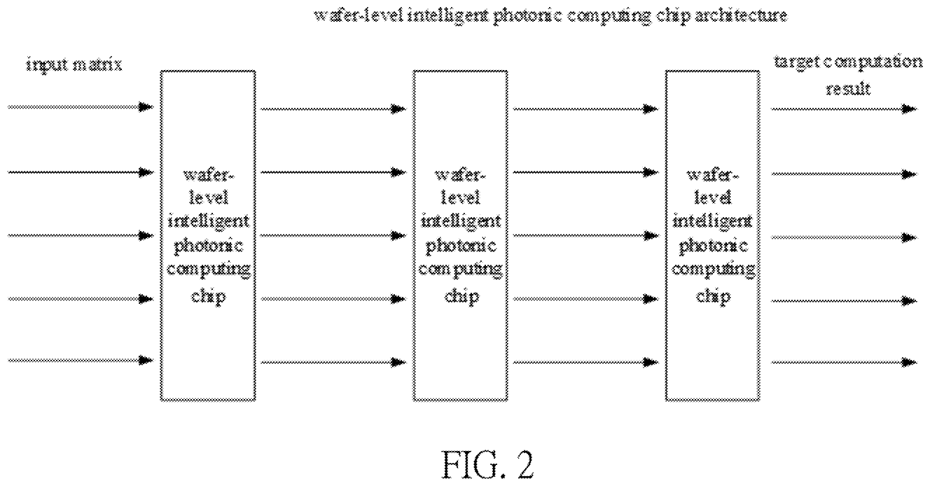

FIG. 2 illustrates a wafer-level intelligent photonic computing chip architecture of the present disclosure. As illustrated in FIG. 2, the architecture may be composed of a plurality of layers of photonic computing chips cascaded. Each part of the chip is driven by intelligent task goals and reversely designed, thus capable of ensuring optimal computing performance.

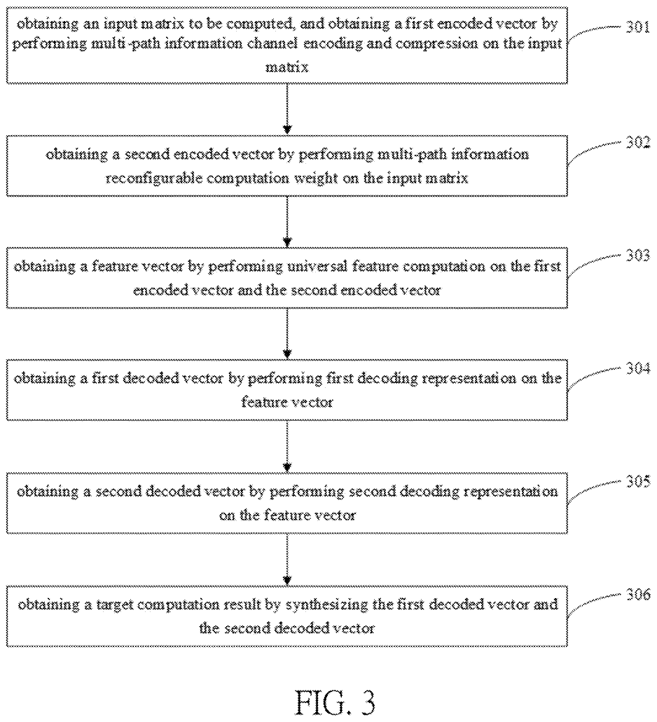

In order to implement the above embodiment, FIG. 3 illustrates a computing method based on a wafer-level intelligent optical computing chip system provides in the disclosure. As illustrated in FIG. 3, the method may include the following steps.

At step 301, an input matrix to be computed is obtained, and a first encoded vector is obtained by performing multi-path information channel encoding and compression on the input matrix.

At step 302, a second encoded vector is obtained by performing multi-path information reconfigurable computation weight on the input matrix.

At step 303, a feature vector is obtained by performing universal feature computation on the first encoded vector and the second encoded vector.

At step 304, a first decoded vector is obtained by performing first decoding representation on the feature vector.

At step 305, a second decoded vector is obtained by performing second decoding representation on the feature vector.

At step 306, a target computation result is obtained by synthesizing the first decoded vector and the second decoded vector.

Processing of user personal information involved in the disclosure—including collection, storage, use, processing, transmission, provision, and disclosure—complies with the provisions of relevant laws and regulations and does not violate public order and good morals.

It should be noted that personal information collected from users shall be used for legitimate and reasonable purposes and shall not be shared or sold outside of these legitimate uses. Furthermore, such collection/sharing shall occur only after obtaining the user's informed consent. This includes, but is not limited to, notifying the user to read a user agreement/a user notification and signing the agreement/authorization including authorization for related user information before the user utilizes the relevant feature. Additionally, any necessary steps shall be taken to safeguard and protect access to such personal information data, and to ensure that others authorized to access the personal information data comply with their privacy policies and procedures.

The disclosure contemplates providing implementations allowing users to selectively block the use of or access to personal information data. That is, the disclosure contemplates providing hardware and/or software to prevent or block access to such personal information data. Risks may be minimized by restricting data collection and deleting data when personal information data is no longer necessary. Furthermore, where applicable, such personal information is de-identified to protect user privacy.

In the technical solution of the disclosure, acquisition, transmission, storage, use, and processing of data all comply with the relevant provisions of national laws and regulations.

It should be noted that in embodiments of the disclosure, certain software, components, models, and other existing solutions in the industry may be mentioned, which should be considered as examples. Their purpose is only to illustrate feasibility of implementation of the technical solution in the disclosure, but it does not mean that the applicant has already or necessarily used the solution.

Reference throughout this specification to “an embodiment,” “some embodiments,” “one embodiment,” “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment,” “in an embodiment,” “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, those skilled in the art may combine and integrate different embodiments or examples described in the description, as well as features of different embodiments or examples, without conflicting with each other.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

Flow chart or any process or method described herein in other manners may represent a module, segment, or portion of code that comprises one or more executable instructions to implement the specified logic function(s) or that comprises one or more executable instructions of the steps of the progress. And the scope of embodiments of the disclosure herein includes other implementations, which may not be in the order shown or discussed, but may be executed in a substantially simultaneous manner or in reverse order based on functions involved. This should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be noted that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The above-mentioned storage medium may be a read-only memory, a magnetic disc, an optical disc, etc.

Although embodiments of the disclosure have been shown and described, it would be appreciated by those skilled in the art that the above embodiments are illustrative and cannot be construed to limit the present disclosure, and changes, alternatives, and modifications can be made in the embodiments without departing from the scope of the present disclosure.

What is claimed is:

1. A wafer-level intelligent photonic computing chip system, comprising:
a high-efficiency information encoder, configured to obtain a first encoded vector by performing multi-path information channel encoding and compression on an input matrix via a diffractive encoder;
a reconfigurable information encoder, configured to obtain a second encoded vector by performing multi-path information reconfigurable computation weight on the input matrix via a phase modulator or an amplitude modulator;
a universal feature computer, configured to obtain a feature vector by performing universal feature computation on the first encoded vector and the second encoded vector;
a high-efficiency feature decoder, configured to obtain a first decoded vector by performing first decoding representation on the feature vector;
a reconfigurable feature decoder, configured to obtain a second decoded vector by performing second decoding representation on the feature vector; and
an output processing element, configured to obtain a target computation result by synthesizing the first decoded vector and the second decoded vector.

2. The system according to claim 1, wherein a structure of the high-efficiency feature decoder is dual to a structure of the high-efficiency information encoder, and a structure of the reconfigurable feature decoder is dua to a structure of the reconfigurable information encoder.

3. The system according to claim 1, wherein the high-efficiency information encoder and the reconfigurable information encoder are deployed on a wafer.

4. The system according to claim 1, wherein the universal feature computer is configured to obtain the feature vector by performing the universal feature computation on the first encoded vector and the second encoded vector via a fully reconfigurable arbitrary matrix computing element based on a Mach-Zehnder interferometer (MZI) or cross-bar structure.

5. The system according to claim 1, further comprising:
an auxiliary, configured to assist the wafer-level intelligent photonic computing chip system to complete a large-scale and high-parameter complex intelligent operation task.

6. The system according to claim 5, wherein the auxiliary comprises a high-speed interface array, a high-speed modulator, a loader, and a data router, wherein
the high-speed interface array is configured for data coupling and readout;
the high-speed modulator is configured for high-speed modulation of computing information;
the loader is configured for loading of an electric control signal; and
the data router is configured for data routing and monitoring.

7. The system according to claim 1, wherein the system comprises a configurable array of high-efficiency information encoders, and each diffractive encoder in the array has a weight distribution orthogonal to each other and independent features.

8. The system according to claim 1, wherein the output processing element is configured to obtain the target computation result by performing weighted synthesization on the first decoded vector and the second decoded vector.

9. A computing method based on a wafer-level intelligent photonic computing chip system, comprising:
obtaining an input matrix to be computed, and obtaining a first encoded vector by performing multi-path information channel encoding and compression on the input matrix;
obtaining a second encoded vector by performing multi-path information reconfigurable computation weight on the input matrix;
obtaining a feature vector by performing universal feature computation on the first encoded vector and the second encoded vector;
obtaining a first decoded vector by performing first decoding representation on the feature vector;
obtaining a second decoded vector by performing second decoding representation on the feature vector; and
obtaining a target computation result by synthesizing the first decoded vector and the second decoded vector.

10. The method according to claim 9, wherein a structure of a high-efficiency feature decoder for performing first decoding representation is dual to a structure of a high-efficiency information encoder for performing multi-path information channel encoding and compression, and a structure of a reconfigurable feature decoder for performing second decoding representation is dua to a structure of a reconfigurable information encoder for performing multi-path information reconfigurable computation weight.

11. The method according to claim 9, wherein a high-efficiency information encoder for performing multi-path information channel encoding and compression and a reconfigurable information encoder for performing multi-path information reconfigurable computation weight are deployed on a wafer.

12. The method according to claim 9, wherein obtaining the feature vector by performing the universal feature computation on the first encoded vector and the second encoded vector comprises:
obtaining the feature vector by performing the universal feature computation on the first encoded vector and the second encoded vector via a fully reconfigurable arbitrary matrix computing element based on a Mach-Zehnder interferometer (MZI) or cross-bar structure.

13. The method according to claim 9, wherein the system comprises:
an auxiliary, configured to assist the wafer-level intelligent photonic computing chip system to complete a large-scale and high-parameter complex intelligent operation task.

14. The method according to claim 13, wherein the auxiliary comprises a high-speed interface array, a high-speed modulator, a loader, and a data router, wherein
the high-speed interface array is configured for data coupling and readout;
the high-speed modulator is configured for high-speed modulation of computing information;
the loader is configured for loading of an electric control signal; and
the data router is configured for data routing and monitoring.

15. The method according to claim 9, wherein the system comprises a configurable array of high-efficiency information encoders, and each diffractive encoder in the array has a weight distribution orthogonal to each other and independent features.

16. The method according to claim 9, wherein obtaining the target computation result by synthesizing the first decoded vector and the second decoded vector comprises:
obtaining the target computation result by performing weighted synthesization on the first decoded vector and the second decoded vector.

17. A non-transiency computer storage medium, storing computer executable instructions which, when executed by a processor, cause a computing method based on a wafer-level intelligent photonic computing chip system to be implemented, wherein the method comprises: obtaining an input matrix to be computed, and obtaining a first encoded vector by performing multi-path information channel encoding and compression on the input matrix;
obtaining a second encoded vector by performing multi-path information reconfigurable computation weight on the input matrix;
obtaining a feature vector by performing universal feature computation on the first encoded vector and the second encoded vector;
obtaining a first decoded vector by performing first decoding representation on the feature vector;
obtaining a second decoded vector by performing second decoding representation on the feature vector; and
obtaining a target computation result by synthesizing the first decoded vector and the second decoded vector.

18. The storage medium according to claim 17, wherein a high-efficiency information encoder for performing multi-path information channel encoding and compression and a reconfigurable information encoder for performing multi-path information reconfigurable computation weight are deployed on a wafer.

19. The storage medium according to claim 17, wherein obtaining the feature vector by performing the universal feature computation on the first encoded vector and the second encoded vector comprises:
obtaining the feature vector by performing the universal feature computation on the first encoded vector and the second encoded vector via a fully reconfigurable arbitrary matrix computing element based on a Mach-Zehnder interferometer (MZI) or cross-bar structure.

20. The storage medium according to claim 17, wherein obtaining the target computation result by synthesizing the first decoded vector and the second decoded vector comprises:
obtaining the target computation result by performing weighted synthesization on the first decoded vector and the second decoded vector.
